(19) United States
(12) Patent Application Publication
(10) Pub. No.: US 2010/0119804 A1
(43) Pub. Date: May 13, 2010

(54) METHOD FOR SPINNING POLYETHER BLOCK AMIDES, AND FIBERS OBTAINED ACCORDING TO THIS METHOD, AS WELL AS PRODUCTS MADE WITH THESE FIBERS

(76) Inventors: Dominique VAN MALDEREN, Schilde (BE); Herbert Maria De Breuck, Merksplas (BE)

Correspondence Address: BACON & THOMAS, PLLC, 625 SLATERS LANE, FOURTH FLOOR, ALEXANDRIA, VA, 22314-1176, US

(21) Appl. No.: 12/617,383

(22) Filed: Nov. 12, 2009

(30) Foreign Application Priority Data
Nov. 13, 2008 (BE) 2008/0618

(51) Int. Cl. D03D 13/00; D01D 5/12; D04H 3/16; D03D 25/00; D04B 1/00; C08G 69/40

(52) U.S. Cl. 428/222; 264/210.5; 264/115; 442/181; 442/304; 525/419

(57) ABSTRACT

Method for spinning polyether block amides (PEBAs) into fibers, whereby use is mainly made of at least one extruder, a cooling system, a sequential line for stretching, a relaxation unit, a heating unit and a winding system, characterized in that polyether block amides are taken as a base material whose initial hardness is situated between shore D15 and 80, better still between shore D20 and 75, even better between shore D27 and 69, and in that the stretched fibers are subjected to a temperature treatment in a heating unit before being wound, whereby their shrinkage is reduced to 0-10%, better still to 0-5% and even better to 0-3%.

The present invention concerns a method for spinning polyether block amides (PEBAs) as well as the fibers obtained with this method.

The present invention also concerns products made with these fibers, in particular those whereby a structure is created in which said PEBA fibers are incorporated in high-quality textile products by means of weaving and/or knitting and/or twining and/or plaiting techniques, or similar techniques. The latter are applied among others in clothing, medical applications and moisture-regulating textile products.

In said high-quality finished textile products are included for example, without restricting the scope of the invention, all sorts of protective clothing, workwear, sportswear, casual clothing, underwear and other types of clothing, but also furniture fabrics and upholstery material for transport means and the like, as well as medical bandages for healing wounds as well as for orthopedic applications and the treatment of burns, as well as support stockings and related products, and further also all sorts of technical textile applications, etc.

In this context, the designation PEBA should be interpreted in the broadest sense.

The designation PEBA refers for example not only to the group of polyether block amides (PEBA) as they are marketed at present among others by the company ARKEMA under the s trade name PEBAX, but it also refers to those offered by the company Evonik A.G. under the name Vestamid, or by EMS-Chemie under the name Grilamid, or by DSM under the name Kellaflex, or also to other similar materials produced by various other suppliers.

Basically, the plasticizer-free PEBA are rather highly efficient thermoplastic engineering elastomers with rather unique properties and easy processing capacities, their quality to be directly spun into high-quality fibers set apart.

In principle, they are formed of linear chains of mainly polyamide blocks which are covalently bonded to flexible polyether segments via an ester link.

In principle, they can be regarded as copolymers, for example prepared by means of polycondensation, starting from a dicarboxylic acid of a polyamide (such as PA6, PA11, PA12, etc.) on the one hand, and a polyether (such as PTMG, PEG, etc.) with two terminal hydroxyl groups on the other hand.

Their general structure can be schematically represented for example as:

*—[CO-A-CO—O—B—O—]—* * (I)

in which

A
represents a polyamide chain, derived from a polyamide which initially comprised two terminal carboxyl groups and has lost them in a reaction;

B
represents a polyoxyalkylene chain derived from a polyoxyalkylene glycol which initially comprised two terminal hydroxyl groups but which has lost them in a reaction as well;

n
is the number of units out of which the polymer chain is built;

*
represents an end group which is for example either a hydroxyl group or another residual group originating for example from compounds which terminate the polymerization, for example originating from a dicarboxylic acid which was added in excess to the reaction mixture.

** represents an end group which is for example hydrogen, or another residual group derived for example from compounds which terminate the polymerization, such as for example a dicarboxylic acid which was added in excess to the reactions mixture.

Apart from the aforesaid segments, the polymer chain may also comprise other functional groups which are usually statistically distributed over the chain then and which are usually built in during the polycondensation reaction by which said materials have usually been synthesized.

In this context are known the specific compositions and production methods of PEBAs, as described among others in FR-PS 7 418 913; DE-OS 28 02 989; DE-OS 28 37 687; DE-OS 25 23 991; EP-A 095 893; DE-OS 27 12 987; DE-OS 27 16 004; U.S. Pat. No. 4,208,493; U.S. Pat. No. 4,230,838; U.S. Pat. No. 4,252,920; JP 7018519; etc.

Further, the PEBAs may be filled with conventional auxiliary ingredients and additives, as well as with agents is having an antistatic effect and/or with nanoparticles, and/or with for example fumed silica, etc.

If need be, they may also comprise biologically active ingredients such as antimicrobial or pharmaceutically active substances which can be released in a controlled way, as described for example in WO 002/28814 by Bayer Aktiengesellschaft, Leverkusen, Germany, for medical applications such as for example in catheters and the like.

The PEBAs are usually processed by mixing them with other thermoplastic base materials in a molten state and by subsequently injection-molding this mixture according to any of the conventional processing methods of thermoplastic materials and/or by extruding it or the like until end products in the form of films, injection molded parts and the like are obtained.

The publications concerned are very diverse and extensive. Thus, for example in EP 0.167.714 by the company Ewald Darken GmbH, Germany, is described a breathable film made of PEBA to be used in insulating roofing material, whereas U.S. Pat. No. 5,584,821 by the company E-Z-EM Inc, USA, and WO 00/28814 by the company Bayer AG, Germany, disclose applications in the medical sector (catheters and the like.)

U.S. Pat. No. 4,361,680 by Ato Chemie, France, describes an application as hot melt adhesive.

In general, we may say that PEBAs, because of their exceptional properties that can be adjusted to the application, currently find applications in many fields.

Thus, we find applications for example in the form of outer soles of shoes for all sorts of top-class sports, where the advantages of these materials as far as shock absorption, light weight, energy return and flexibility are put to use, also at low temperatures.

In winter sports materials such as ski boots, advantages such as light weight and resistance to extreme conditions such as low temperatures, UV resistance and moisture resistance are particularly useful.

Medical applications, such as for example the above-mentioned catheters, use the high flexibility properties, at high as well as low temperatures, and also the general softness of such materials.

In the field of electronics and electricity, PEBAs are used as housing material, for cable and wire insulation, or for separate components, etc.

Further applications are found in breathing films and non-wovens.

Hydrophilic variants are used for their antistatic and dust-repellent properties.

Because, very often, no additives are required to obtain these properties, PEBA materials can be usually recycled at is the end of their useful life span.

As far as fiber manufacturing from PEBAs is concerned, the present state of the art is far more limited, however.

From U.S. Pat. No. 4,923,742 by the company Kimberly-Clark Corporation is known in this field a non-woven elastic fleece, produced according to what is called the “melt blowing” technique, which is formed for about fifty percent from a PEBA and for the other fifty percent from individual particles selected from the group of activated carbon and other powdery absorbing materials.

They are then applied onto the non-woven web in a separate step or processed into it.

The main application of such a web can be found in the field of absorbing nappies, sanitary towels and the like.

A disadvantage of this “melt blowing” technique for non-woven materials is that, in this manner, no fibers or filaments can be formed having the required mechanical and chemical properties to be wound as a fiber on a bobbin so as to be subsequently converted into high-quality fabrics by means of knitting, weaving, twining or similar techniques.

Also known in this context is for example the processing of PEBAs in composite fibers so as to form elastic antistatic polyester fibers.

The PEBA base materials, as described for example in JP 5.515.833, JP 57-1176219, JP 55-122020, are hereby always blended in a molten state with other thermoplastic materials, for example with polyamides or polyesters, to be subsequently processed, if necessary and after the required antistatics have been incorporated or after having been subjected to a surface treatment, into a finished product in the form of composite fibers.

Knitted or woven products can also be made with fibers of a similar antistatic thermoplastic polymer mixture composed of PEBA, polyester and/or polyamides, as described for example in JP 81-99454 by the company Toray Industries, Japan.

From JP 70-18519 by the company Teijin LtD is known an elastic fiber made of a PEBA having a very special composition which can be formed in a “melt spinning” process, but which cannot be stretched but in a large number (up to 20) of successive steps. Moreover, the product is apparently very sensitive to the composition and to impurities during the polymerization, and it is also strongly affected by temperature influences and discoloring during the extrusion.

It is not mentioned whether such a fiber is suitable to be further processed into useful goods by means of typical knitting, twining, weaving or plaiting techniques.

Thus, for example, WO 03/035952 by the company E.I. Dupont de Nemours describes a hetero-composed synthetic yarn composed of different elements, i.e. a bi-constituent yarn that is combined with a second accompanying yarn, which is not specified any further, whereby the aforesaid bi-constituent yarn comprises at least one filament with an axial core, formed of a thermoplastic elastomer, and whereby a multitude of wings are attached to this core, whereby these wings are in turn formed of a thermoplastic, non-elastomeric polymer.

Also a method is described, represented for example in FIG. 5 and the following figures, for manufacturing such a bi-constituent yarn, which method implies guiding a molten thermoplastic polymer on the one hand and a molten thermoplastic elastomer on the other hand through a spinning plate so as to produce multiple elastic synthetic fibers, including an axial core formed of an elastomeric polymer and multiple wings which are attached to said core and which are made of a non-elastic polymer.

In order to provide for a satisfactory attachment, adhesive promoters must be quite often added to the base materials, which tend to have a negative effect on their good properties.

Such a bi-constituent yarn can then be further processed together with other yarns by placing them for example side by side with the bi-constituent yarn or by giving it a conformation with a core having an eccentric or concentric sheat, or as wings with a core, or also as wings with a sheat and a core, or the like.

Such a bi-constituent yarn can be finished as a monofilament bi-constituent yarn or as a thread formed of a large variety of multiple identical filaments which must always work in conjunction with one or several accompanying threads so as to obtain the required chemical and mechanical properties.

Consequently, they can only be obtained by composing the thread of at least three parts and not by composing or manufacturing a monofilament having the required inherent properties.

A major disadvantage is that manufacturing a thread having such a structure or design is very complicated, labor-intensive, wasteful of energy and consequently environmentally unfriendly.

Moreover, such threads only have limited application possibilities, for example in fabrics where the particularly large own volume together with a large elongation and resilience are of major importance.

Thus, WO 99/45183 by the company Optimer Inc, USA describes a synthetic two-component fiber, formed of a non-elastomeric polyamide on the one hand and a thermoplastic elastomer on the other hand, whereby the first one is selected for example from the polyamide group such as for example nylon 6 and the second one is selected from the group of polyether block copolyamides, in particular Pebax 5533, and from the group of elastomeric polyurethanes based on polycaprolactone polyester, such as for example Pellethane 2102, whereby the synthetic two-component fiber has as a main characteristic that it is self-shrinking.

Both synthetic groups are separately melted and brought into contact with one another for example in a “Y”-shaped spinning head so as to form the synthetic two-component fiber.

The inventors did not succeed in this case either to combine the desired inherent chemical and mechanical properties in a single thread.

Thus, WO 98/19623 by the company Gilette Canada Inc discloses a multicomponent co-extruded floss thread made according to the “island in the sea concept” of one or several core filaments formed of a first material and a coating of a second material which moreover has a sealed outer surface.

In order to form such a multicomponent floss thread, at least two extruders are used: the first one to first s extrude the core and the second one to subsequently apply the coating.

The coating consists for example of a polyether block copolyamide such as Pebax 2533 or Hytrel 3078, either or to not filled with an abrasive or a lubricant, whereas the “sea” component or components may be formed for example of nylon 4.0.

Here as well, composed threads have to be formed and manufactured, in particular according to the “island in the sea” concept, because it is impossible to incorporate the desired chemical and mechanical properties inherently in a single thread.

WO 02/080801 by D. Brown, I. Hill e.a. discloses a synthetic tape for flossing teeth which is based on a supporting structure formed of a thermoplastic elastomer provided in a solid form, selected from the group of polystyrenes, mixtures of polyolefins, elastomer alloys, polyurethanes, copolyesters, polyamides and mixtures and/or copolymers thereof, whereby said tape has an elongation at fracture of less than 50%, and an elastic limit of less than 25% and in which an additive can be processed consisting of polydimethylsiloxanes of a very high molecular weight embedded in an organic resin or of calcium stearate or mixtures thereof and/or whereby it is provided with a coating which is released in the oral cavity when flossing.

The processing circumstances, including the orientation of the synthetic chains obtained by stretching, are hereby selected such that the tape has a flex/twist index situated between 2.5 and about 5, which appears to be a main characteristic in order to efficiently floss the teeth.

Although the invention describes a tape which can be based on the processing of polyether block amides, the chemical and mechanical properties required for flossing are merely obtained by the incorporation of significant amounts of additives, fillers and the application of specific coatings.

WO 93/18891 by the Minnesota Mining and Manufacturing Co, USA, however, discloses the composition and production of abrasive filaments formed of a hardened organic polymer, which may be a polyether block amide, filled to a large extent with abrasive particles, however.

In order to obtain a good bond between the abrasive particles and the polymer, special bonding agents usually have to be used.

In order to obtain the required properties, a composed thread is usually manufactured whereby a core thread is surrounded by an abrasive coating formed of a second polymer filled with abrasive particles.

Because of the specific requirements that such an abrasive filament must meet, in particular resistance to bending fatigue, their composition and production method strongly differs from the fibers described in the present invention.

In short, we can say that, according to the present state of the art, spinning of PEBAs into high-quality fibers, having moreover the appropriate physical and chemical properties to be processed into useful high-quality textile products by means of a knitting and/or twining and/or weaving and/or plaiting technique or the like, is still not feasible in practice, neither in the form of a monofilament, nor in the form of a multifilament.

Undoubtedly, this can be regarded as a major disadvantage and a serious limitation of the useful applications of this type of high-quality materials.

Therefore, the invention aims to remedy these and other disadvantages by providing a method for spinning PEBAs into fibers, whereby the properties of the fibers are adjusted so that they can be processed into useful finished textile products according to one of the above-mentioned techniques.

This aim is reached by applying a method for spinning polyether block amides (PEBAs) into fibers, making use of at least one extruder, a cooling system, a sequential line for stretching, a relaxation unit, a heating unit and a winding system, characterized in that polyether block amides are taken as starting materials whose initial hardness is situated between shore D15 and 80, better still between shore D20 and 75, even better still between shore D27 and 69, and in that the stretched fibers are subjected to a temperature treatment in a heating unit before being wound, whereby their shrinkage is reduced to 0-10%, better still to 0-5% and even better to 0-3%.

In another embodiment, polyether block amides whose initial hardness is situated between shore A70 and 99, better still between A 75 and 95, even better between shore A 77 and 92 are taken as starting material.

This offers the advantage that the remarkable properties of the PEBAs, the chemical as well as the physical properties, can now also be put to use in other applications that were not feasible up to now.

Examples of such end applications are, without being restrictive in any way, high-quality, light-weight and where applicable moisture-regulating clothes as well as protective clothing, workwear, sportswear, casual wear, underwear and other types of clothing, but also furniture fabrics and upholstery material for transport means and the like, medical bandages for healing wounds as well as for orthopedic applications and the treatment of burns, support stockings and related products, and further also all sorts of technical textile applications.

A major advantage thereof is that, by making use of these PEBA filaments, as opposed to filaments made of more traditional materials, textile structures with better properties are obtained, in particular having a light weight, excellent elasticity and shock absorption, a good regulation of the moisture balance with the accompanying feeling of comfort, a good mixability with other fibers, an improved general permeability of the textile structure, good recycling properties of the materials, etc.

In order to better explain the characteristics of the invention, the following preferred embodiments of the method for spinning fibers according to the invention and the fibers obtained in this manner and which make it possible to produce finished textile products with them by means of one of the above-mentioned techniques are described by way of example only without being limitative is in any way.

In a preferred embodiment, in order to form a monofilament fiber according to the invention, one proceeds for example as follows.

A particular type of PEBA is taken as a base polymer, characterized by a hardness situated between shore A 70 and 99, better still between A 75 and 95, even better between A 77 to 92.

In another preferred embodiment, however, a type of PEBA whose hardness is situated between shore D 15 and 80, better still between D 20 and 75, even better between D 27 to 69 is taken as a basis.

In a practical preferred embodiment, the PEBA monofilaments are manufactured in a production line which is mainly composed of at least one extruder, further a cooling unit, a sequential line for stretching the filaments, an arrangement for controlled relaxation and a winding system.

The extruder itself has a supply system to feed the polymer into the extruder.

Whether the polymer is either or not dried depends on whether the polymer is either or not packed in a moisture-resistant packaging.

In a preferred embodiment, the base polymer is dried for some hours in a ventilated furnace before extruding it.

In a further preferred embodiment, the supply system is also provided with an installation to blanket the introduced polymer with dry air so as to protect the material from any influences of the atmospheric humidity.

In another preferred embodiment, said blanketing is provided for by means of nitrogen instead of dry air.

In principle, the extruder itself mainly consists of a shaft with one or several mixing screws, variable heating zones, a pump for spinning, a screen pack and a spinning plate.

In a preferred embodiment, a simple extruder is used hereby.

In a further preferred embodiment, the extruder is a co-rotating double screw extruder.

In yet another preferred embodiment, the extruder is an anti-rotating double screw extruder.

In a preferred embodiment, for the extrusion of PEBA monofilaments, the temperature in the extruder varies between 120° C. and 270° C., better still between 130° C. and 250° C., and even better between 160° C. and 230° C.

Generally speaking, an extrusion temperature is used which is lower than when processing conventional polyamide copolymers or mixtures thereof.

The spinning plate can be formed of a varying number of spinning holes, varying between 1 and 120.

The number of spinning holes used hereby directly depends on the thickness of the filaments and the output of the machine.

Together with the rather low extrusion temperature, this must prevent discoloring and degrading of the material in the extruder and the accompanying loss of quality of the monofilaments.

The geometric shape of the extruded filament may vary from a round filament to more complicated morphologic structures, whereby other properties are obtained depending on the shape, mechanically (e.g. tensile strength and elasticity) as well as physically speaking (moisture regulation).

The shape of the filament is hereby mainly determined by the morphology of the mould openings.

In a preferred embodiment, the subsequent cooling system consists of an air-cooled unit.

In a further preferred embodiment, this cooling system preferably consists of a water-cooled system, in particular a cooling-water bath.

In the water bath, the filaments are guided across a built-in deflection point whose position and shape is adapted to the shore hardness of the base material so as to be directed in the prolongation of the sequential line.

In this case, the sequential line consists of a spin finish unit, a series of rollers, and ovens (preferably four-roller systems), and three hot-air circulation ovens.

For, when extruding PEBA monofilaments, it is also possible to apply a spin finish, but preferably not in order to maintain the optimal properties of the PEBA in the filament.

In a preferred embodiment, the spin finish unit, in case it is used, is provided in the front of the line, immediately after the cooling unit.

In a further preferred embodiment, the spin finish unit is installed after the stretching and relaxation phase, right before the winder.

In the sequential line, the monofilaments are subsequently stretched at a stretch ratio between 1 and 12, better still between 1 and 8, even better between 2 and 6.

Traditionally, three ovens in succession are used, whose temperatures can be set from ambient temperature (oven switched off) to some 160° C.

In a preferred embodiment according to the invention, the first two ovens are hereby set at ambient temperature, and the third oven is preferably set between 60 and 110° C.

In a further preferred embodiment, there is no third oven for the heating, but the last relaxation roller itself is heated to a temperature situated between 60 and 110° C.

According to the invention, this method optimizes the properties of the filaments, resulting in a better processing of the filaments in the subsequent production process.

In the final step of the stretching process, a relaxation phase of 0 to 10%, better still of 0 to 8%, and even better of 0 to 5% is implemented in a further preferred embodiment.

When these steps according to the invention are not carried out, this results in tension being built up in the bobbins, making it difficult or even impossible to unwind the filament.

At the end of the production process, the monofilaments are wound on a bobbin or reel.

Its selection depends on the client's wishes as far as weight, length and thickness of the produced filaments are concerned.

The produced monofilaments can hereby vary in thickness from 15 den to 3000 den, depending on the market's demand and the selected mould opening.

If a multifilament is being produced, more or less the same method is followed according to a preferred embodiment, but with the following major differences:
the multifilament yarns being produced according to the invention have a dpf of 1-30, better still of 2-20, and even better of 3 to 6 dpf.

As opposed to the production of monofilament fibers, as described above, cooled stretching rollers are used in the production of multifilament fibers according to the invention, save for the last relaxation rollers whose temperature is increased then.

A further particularity of the method according to the invention is that relatively low extrusion speeds are applied compared to the multifilament extrusion of other thermoplasts such as PA, PET, PP, etc.

Also, due to the nature of the polymer, it is indicated not to stretch too much.

A large number of the properties of the yarn would get lost then.

In a practical preferred embodiment, this is done for example in the following manner and under the following conditions.

PEBA multifilaments are manufactured in a multifilament extrusion line built in the usual manner.

This extrusion line is mainly composed of the actual extruder, a cooling unit, in this case a spin finish unit, followed by a sequential line for stretching and relaxing the filaments, and finally a winding system.

The extruder contains a supply system to feed the polymer into the extruder.

The supply system may be either or not equipped with an installation for blanketing the introduced polymer by means of dry air or nitrogen so as to protect the material against any influences of (air) moisture.

The extruder itself is hereby composed of a shaft with a mixing screw or screws, variable heating zones, a spinning pump, a screen pack and a spinning plate.

The spinning plate can be built with a varying number of spinning holes. The number of spinning holes used depends directly on the thickness of the filaments, the number of filaments to be produced and the output of the machine.

The extruder may be a single screw as well as a double screw, co-rotating as well as anti-rotating.

When extruding PEBA multifilaments, the temperature in the extruder varies from 130° C. to 260° C., preferably from 160° C. to 230° C.

Together with the number of selected spinning holes in the is spinning plate, this must avoid any discoloring or degrading of the material in the extruder, and associated to this any loss of quality of the multifilaments.

The speeds of the multifilament extrusion may hereby vary from 500 to 5000 m/min, depending on the type of PEBA, the thickness of the filament, the properties of the extruder (capacity, spinning pump, screen pack, etc.) and the aimed output.

In a preferred embodiment, extrusion speeds situated between 1000 to 2000 m/min are maintained, for example.

Compared to the extrusion of other thermoplasts such as PA, PET, PP, etc. this is a relatively low extrusion speed.

The cooling system may consist of a water-cooled system or an air-cooled system, but for the manufacturing of multifilaments, use is made of an air-cooled system in a preferred embodiment, in particular of what is called an “air quench system”.

This is mainly composed of an air shaft whereby a certain flow of cooling air is blown over the yarns in order to cool the melt to filaments that can be further stretched and wound.

The speed of the cooled air can hereby vary from 0.2 m/s to 2 m/s, better still from 0.4 to 1.5 m/s, and even better from 0.5 m/s to 1.2 m/s, depending on the thickness of the filaments to be extruded.

In principle, the sequential line is further composed of a spin finish unit and a series of rollers, whereby the latter can be either or not heated or cooled, depending on their position in the machine.

When extruding PEBA multifilaments, it is also possible to apply “spin finish”, but preferably not in order to maintain the optimal properties of the PEBA in the filament.

If need be, this “spin finish” is applied by means of a wetting roller system whereby the wetting roller turns at a speed between 1 to 15 revolutions per minute, in a preferred embodiment at a speed situated between 7 and 12 revolutions per minute.

In the sequential line, the multifilaments are further stretched then at a stretching ratio between 1 and 12, better still between 1 and 8, and even better between 1 and 6.

The temperatures of the varying rollers of the sequential line, i.e. the receiving roller, the second roller, the so-called roller pairs, occasionally other rollers, a relaxation roller and finally a receiving roller are set at ambient temperature or cooled from 0-20° C. to 170° C.

In a preferred embodiment, the temperature of the receiving roller and the second roller is set at ambient temperature and the temperature of the pairs and/or third set of rollers is set at a temperature situated between ambient temperature and 170° C., better still between 20° C. and 60° C.

In a preferred embodiment, the temperature of the relaxation roller is hereby set between 60° C. and 120° C.

In the final step of the stretching process, it is indicated to built in a relaxation phase from 0 to 15%, better still from 0 to 10%, and even better from 0 to 5%.

This method optimizes the properties of the multifilaments, which results in a better processing of the filaments in the further production process.

The stretching and speed are set by adjusting the individual rollers.

In a preferred embodiment, for example when extruding PEBA having a shore A 85 so as to form a multifilament, the following roller speeds are maintained:

for the first roller (receiving roller) a speed between 500 and 1200 m/min, better still between 700 and 1100 m/min, for the second roller a speed between 800 and 1800 m/min, better still between 1000 and 1500 m/min, for the pairs of rollers a speed between 1000 and 2700 m/min, better still between 1100 m/min and 2000 m/min and for the relaxation roller a speed between 950 and 2700 m/min, better still between 1050 and 2000 m/min.

The dimensions of the produced multifilaments may vary from 15-den to 3000-den, depending on the demands of the market and the selected mould opening.

The den/filament (dpf) varies between 1 and 30 dpf, better still between 3 and 6 dpf.

The geometrical shape of the individually extruded filaments may vary from a round filament to more complicated morphological structures, whereby the properties vary depending on the shape, both mechanical (e.g. tensile strength and elasticity) and physical (moisture regulation).

The shape is determined by the morphology of the mould openings.

With such multifilaments, the produced yarns may be either or not entangled.

Entangling produces ‘tangles’ in the yarn at regular distances which may provide for a better processing in knitting, weaving or plaiting machines.

In a preferred embodiment, the entangling produces 10 to 40 tangles/m, better still 20 to 30 tangles/m.

The entangling pressure applied hereby varies from 2 to 12 bar, better still from 4 to 8 bar.

The multifilament that is produced in this manner according to the invention can be a CF (continuous filament), a BCF (bulk continuous filament), a HOY (High oriented yarn), a

POY (partial oriented yarn), a LOY (low oriented yarn), a MOY (medium oriented yarn) as well as a FDY (full drawned yarn).

At the end of the production process, the filaments are wound on a bobbin or reel.

The selection thereof depends on what the client prefers as well as on the weight, length and thickness of the produced filaments.

In a further preferred embodiment, the produced monofilaments as well as the multifilaments are used to finally create textile structures with extra added value.

Depending on the specifications of the finished product and what is required, a fabric (weaving), knitwear (knitting) or a plaiting (plaiting, twining) is formed.

In this way, fabrics are formed for example, occasionally in combination with other fibers, which are suitable for applications in the field of protective clothing and sportswear, medical applications, both inside and on the outside of the body, moisture and temperature regulation via textile products, etc.

Examples thereof are for example, without being limitative in any way, high-quality, light-weight and if appropriate moisture-regulating clothing as well as protective clothing, workwear, sportswear, casual clothing, underwear and other types of clothing, as well as furniture fabrics, upholstery material, cladding of transport means, medical bandages, for healing wounds as well as for orthopedic applications and the treatment of burns, support stockings and related products, and different technical textile applications meeting very specific chemical as well as physical requirements.

A major advantage thereof is also that, by using these PEBA filaments, as opposed to filaments made of more conventional materials, the properties of the textile structure are improved, in particular as far as light weight, excellent elasticity and shock absorption are concerned, a good moisture balance regulation and the accompanying feeling of comfort, a good mixability with other fibers, improved general permeability of the textile structure, good recycling properties of the materials, etc.

According to a further preferred embodiment, the produced fibers are further combined with other textile fibers, such as PET, PA (nylon), PP, PBT, PLA, TPU, TPE and other known textile fibers.

According to a further preferred embodiment, the PEBA base materials are further put to use by incorporating additives (e.g. plasticizers, nanoparticles, antioxidants, UV stabilizers, incorporation of active ingredients such as antimicrobic, antiparasitic, fungicidal, bacteriostatic or wound-healing agents, antistatics, electrically conductive elements, radiation-absorbing or reflecting materials, etc.)

In a further preferred embodiment, the textile products made with the filaments according to the invention are treated further in order to improve their appearance or aesthetic aspect or to add additional surface-related properties.

The present invention is by no means restricted to the embodiment(s) described by way of example; on the contrary, such a method and fibers made in this way, as well as finished products containing these fibers can be realized according to different variants while still remaining within the scope of the invention.

1-30. (canceled)

31. Method for spinning polyether block amides (PEBAs) into fibers, comprising:
providing and using at least one extruder, a cooling system a sequential line for stretching, a relaxation unit, a heating unit and a winding system;
using polyether block amides as a starting material for extrusion of fibers, the initial hardness of which is between shore D15 and 80; stretching the fibers; and
subjecting the stretched fibers to a temperature treatment in a heating unit before being wound, wherein shrinkage of the fibers is reduced to 0-10%.

32. Method according to claim 31, wherein the temperature treatment comprises re-heating the fibers up to a temperature between 60 and 110° C.

33. Method according to claim 31, wherein the temperature treatment is carried out in an air-circulated oven.

34. Method according to claim 31, wherein the polyether block amides used as a starting material have an initial hardness between shore A 70 and 99.

35. Method according to claim 31, wherein either monofilament or multifilament fibers are formed.

36. Method according to claim 35, wherein, in the case of a monofilament fiber, an extrusion temperature is set between 120° C. and 270° C.

37. Method according to claim 36, wherein the extruded filament is cooled in a water bath, the latter being provided with a deflection point whose position and shape is determined by the hardness of the filament.

38. Method according to claim 36, wherein the extruded monofilament in the sequential line is stretched at a stretching ratio of 1 to 12.

39. Method according to claim 38, wherein, after the stretching process, a relaxation operation is carried out from 0 to 10%.

40. Method according to claim 36, wherein monofilament fibers are formed whose dimensions are between 15-den and 300-den.

41. Method according to claim 35, wherein, in the case of a multifilament, the extrusion temperature is set between 130° C. and 260° C.

42. Method according to claim 35, wherein, in the case of a multifilament, an extrusion speed is selected between 500 m/min and 5000 m/min.

43. Method according to claim 41, wherein the extruded multifilament is cooled in an air-cooled (air quench) system.

44. Method according to claim 43, wherein the air speed of the cooling system is between 0.2 m/s to 2 m/s.

45. Method according to claim 41, wherein a “spin finish” is applied on the extruded multifilament, and the wetting roller turns at a speed of 1 revolutions per minute to 15 revolutions per minute.

46. Method according to claim 41, wherein different rollers are used in the sequential line, among others a receiving roller, a second roller, pairs of rollers, other rollers and finally a relaxation roller.

47. Method according to claim 46, wherein the rollers are maintained at different temperatures of between 0° C. and 170° C. and the second roller at ambient temperature, the pairs or rollers and/or any further rollers between ambient temperature and 170° C.

48. Method according to claim 41, wherein the multifilaments are stretched at a stretching ratio of 1 to 12.

49. Method according to claim 46, wherein the temperature of the relaxation roller is set between 60° C. and 120° C.

50. Method according to claim 49, wherein a relaxation is carried out from 0% to 15%.

51. Method according to claim 46, wherein, when extruding a PEBA having a hardness shore A 85 for forming a multifilament, the following roller speeds are maintained in the sequential line:
for the (first) receiving roller a speed between 500 m/min and 1200 m/min; for the second roller a speed between 800 m/min and 1800 m/min; for the pairs of rollers a speed between 1000 m/min and 2700 m/min; and for the relaxation roller a speed between 950 m/min and 2700 m/min.

52. Method according to claim 41, wherein an entanglement is carried out on the extruded multifilaments varying from 10 to 40 tangles/m, and in that an entanglement pressure is applied thereby between 2 bar and 12 bar.

53. Method according to claim 41, wherein multifilaments are produced whose dimensions are between 15 den and 3000 den.

54. Method according to claim 53, wherein the den/filament (dpf) is between 1 to 30 dpf.

55. Method according to claim 41, wherein a multifilament fiber is formed which can be classified in one of the following classifications:
CF (continuous filament); BCF (bulk continuous filament); HOY (high oriented yarn);
POY (partial oriented yarn); LOY (low oriented yarn); MOY (medium oriented yarn); FDY (fully drawn yarn); or similar.

56. Fiber, produced according to the method of claim 31.

57. Textile, obtained by twining and/or knitting and/or plaiting and/or weaving fiber made according to claim 56.

58. Textile according to claim 57, formed with other textile fibers.

59. Textile according to claim 57, having outstanding moisture-regulating and/or temperature regulating properties.

60. Clothing and/or upholstery material and/or fabric for medical and related applications, and/or technical fabric, made of a textile made according to claim 57.
